(19) United States
(12) Patent Application Publication
(10) Pub. No.: US 2015/0187114 A1
(43) Pub. Date: Jul. 2, 2015

(54) METHOD AND APPARATUS FOR EDITING 3D CHARACTER MOTION

(71) Applicant: Electronics and Telecommunications Research Institute, Daejeon (KR)

(72) Inventors: YEJIN KIM, Daejeon (KR); MYUNGGYU KIM, Daejeon (KR); SEONGMIN BAEK, Daejeon (KR); JONGSUNG KIM, Daejeon (KR); ILKWON JEONG, Daejeon (KR)

(21) Appl. No.: 14/583,434

(22) Filed: Dec. 26, 2014

(30) Foreign Application Priority Data
Dec. 26, 2013 (KR) 10-2013-0164323

(51) Int. Cl. G06T 13/40; G06T 19/20

(52) U.S. Cl. CPC G06T 13/40; G06T 19/20; G06T 2219/2004

(57) ABSTRACT

A method of editing a 3D character motion and an apparatus using the same, the method including analyzing correlations between degrees of freedom of joints with respect to a plurality of sample motions, and generating a new character motion desired by a user by editing a 3D character motion input by the user, wherein when a key joint is manipulated by the user, positions of other joints are transformed by use of the analyzed correlations between degrees of freedoms of the joints, so that the new character motion is generated.

### CROSS-REFERENCE TO RELATED APPLICATION

This application claims priority from Korean Patent Application No. 10-2013-0164323, filed on Dec. 26, 2013, the entire disclosure of which is incorporated herein by reference for all purposes.

### BACKGROUND

1. Field

The following description relates to technology for content creation and editing, and more particularly, to technology for a 3D virtual character creation and editing.

2. Description of the Related Art

By editing a motion of a 3D virtual character connected through a plurality of joints, a new character animation having a style desired by a user may be generated. Key-frame animation is one example of methods of generating such a new character animation. The key-frame animation is performed in such a manner that a user edits frames serving as keys among all frames, and in-between frames between the key frames are automatically interpolated by a system, so that a final animation is generated. Accordingly, in order to reflect a motion of a desired style on the animation, a user needs to transform a posture of a character included in key frames, and then specify a time specific position of an animation sequence.

Representative examples of the motion editing software using the key frame method include Maya, 3ds Max and Softimage manufactured by Autodesk Inc. in US. In transforming the posture of a 3D character model, the commercial software provides translation, rotation and channel with respect to a degree of freedom of each joint to transform a posture, which improves the flexibility of editing. However, the commercial software does not automatically correct the transformed posture in terms of natural look or physical validity. In particular, in order to manually adjust all the degrees of freedom to generate a motion of a desired style, the user is required to have an expertise to analyze and understand a motion and a posture in consideration of inverse kinematics, so it is difficult for an unskilled person to generate a high quality motion.

### SUMMARY

The following description relates to a 3D character motion editing method enabling a user to generate a new character animation of a style desired by easily and rapidly editing a character motion in editing a 3D charter motion through the key frame animation scheme, and a 3D character motion editing apparatus using the same.

In one general aspect, a method of editing a motion of a 3D character includes: analyzing correlations between degrees of freedom of joints from a plurality of sample motions; and generating a new character motion desired by a user by editing a 3D character motion input from the user, wherein when a key joint is manipulated by the user, positions of other joints are transformed by use of the analyzed correlations between degrees of freedoms of the joints, so that the new character motion is generated.

As is apparent from the above, when a user generates a new character motion of a desired style by editing an input motion provided in a 3D character motion type, a plurality of joints having correlation with a key joint are simultaneously adjusted if the user manipulates only the key join, so that even a layman having little experience in transforming the character posture can easily edit the input motion without the expertise in the motion analysis and editing.

In addition, since the input motion is transformed by only using a predetermined key joint, there is no need to repeatedly adjust a plurality of degrees of freedom during the character motion editing, thereby significantly reducing the editing time. In addition, since the physical validity included in motion data is applied to the editing process, a transformed motion is represented to be more natural.

Other features and aspects will be apparent from the following detailed description, the drawings, and the claims.

### BRIEF DESCRIPTION OF THE DRAWINGS

FIG. 1 is a reference diagram illustrating positions of main joints of a 3D character and examples of key joints that may be used by a user for a 3D character editing in accordance with an embodiment of the present disclosure.

FIG. 2 is a flowchart showing a method of editing a 3D character motion in accordance with an embodiment of the present disclosure.

FIG. 3 is a flowchart showing a detailed process of generating a new character motion of FIG. 2 in accordance with an embodiment of the present disclosure.

FIG. 4 is a reference diagram illustrating an example in which key frames extracted from sample motions are compared and postures are grouped in operation 200 of analyzing correlations between degrees of freedom of joints of the sample motion of FIG. 2.

FIG. 5 is a reference diagram illustrating a physical enhancement of FIG. 3.

FIG. 6 is a block diagram illustrating a configuration of an apparatus for editing a 3D character motion in accordance with an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness. In addition, while parts of the present invention are named and described below with reference to their functionalities, alternative terminology may be employed, as desired by a user, operator, or according to conventional practice, without altering the content of the disclosure.

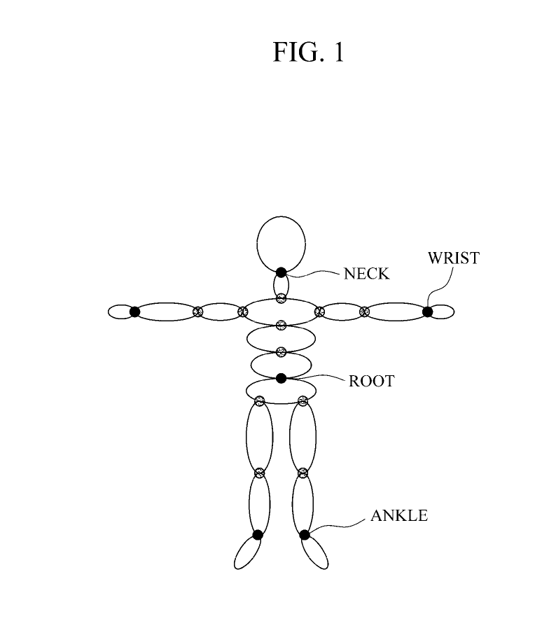

FIG. 1 is a reference diagram illustrating positions of main joints of a 3D character and examples of key joints that may be used by a user for a 3D character editing in accordance with an embodiment of the present disclosure.

Referring to FIG. 1, a 3D character is composed of a plurality of joints. Main joints include a root joint, and lower level joints articulated to the root joint, such as a head joint, hand joints and foot joints. The respective joints of a 3D character except for the root joint each has one or more degrees of freedom with respect to the X-axis, the Y-axis and the Z-axis. Accordingly, the total degrees of freedom available for a posture editing is 3·(the number of joints except for the root joint)+6. Here, 6 represents the value of degrees of freedom of translation and rotation of the root joint with respect to the X-axis, the Y-axis and the Z-axis.

The present disclosure relates to technology for generating a new character animation of a desired style from a motion of a 3D character received by a user (hereinafter, referred to as ‘an input motion’), by use of the key-frame animation scheme. According to the key-frame animation scheme, when a user edits key frames serving as keys in an input motion, an editing apparatus automatically performs interpolation on in-between frames provided between the key frames, thereby generating a final animation. In this case, the input motion edited by the user may be not a motion, whose correlations are continuous and regular, such as a gesture or a biped walking, but a motion, whose correlations are discontinuous and irregular, such as a performance motion.

The present disclosure suggests a user manipulation technique for generating a natural and realistic 3D character motion, and more particularly, a technique enabling even a layman having less experience in transforming a character posture to easily edit a character motion. To this end, the present disclosure allows other joints to be automatically transformed when a user manipulates a certain joint, by use of correlations between joints, thereby enabling the user to easily and simply editing a motion. In addition, since the input motion is transformed by only manipulating a certain joint, there is no need to repeatedly adjust all the degrees of freedom of joints associated with a style desired by a user, thereby reducing the editing time.

The certain joint manipulated by a user is a key joint, and other joints may be intermediate joints dependent on the key joint. The key joint may be designated in advance. Joints having important roles when a character takes a certain posture may be designated as key joints. For example, the key joint may be at least one of a neck joint, a wrist joint, an ankle joint and a root joint of a 3D character. In this case, the position of the key joint is used as an input parameter. In addition, the key joint may be designated by a user and manipulated by the user.

According to the above described editing technology, an input motion may be transformed as a user manipulates only a certain joint, so that the motion is easily and rapidly edited into a new character motion having a style desired by the user. The present technology is applied to all the fields associated with generating a new animation by editing a 3D character motion. Hereinafter, the technology for easy and rapid 3D character motion editing will be described in detail with reference to the accompanying drawings.

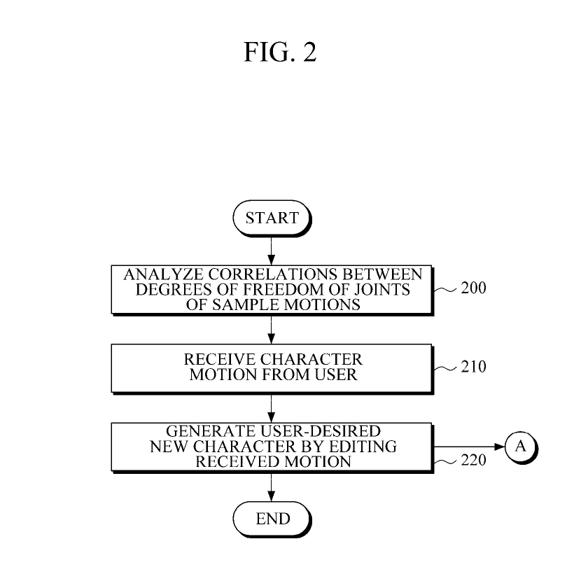

FIG. 2 is a flowchart showing a method of editing a 3D character motion in accordance with an embodiment of the present disclosure.

Referring to FIG. 2, a 3D character motion editing apparatus in accordance with an embodiment of the present disclosure (hereinafter, referred to as ‘an editing apparatus’) analyzes correlations between degrees of freedom of joints from sample motions (DoF correlation analysis) (200). Sample motions are exemplary motions that may be stored in a database so as to be read. The editing apparatus analyses correlations between degrees of freedom of joints by reading the sampling motions from the database. The database may be provided in the form of a memory provided inside the editing apparatus, or may be provided as a server separated from the editing apparatus. In this case, the database is provided as a separate server, the editing apparatus may connect to the database by using a web. The correlations between the degrees of freedom of joints analyzed from the provided sample motions are used later for a user to transform an input motion and generate a new style motion animation.

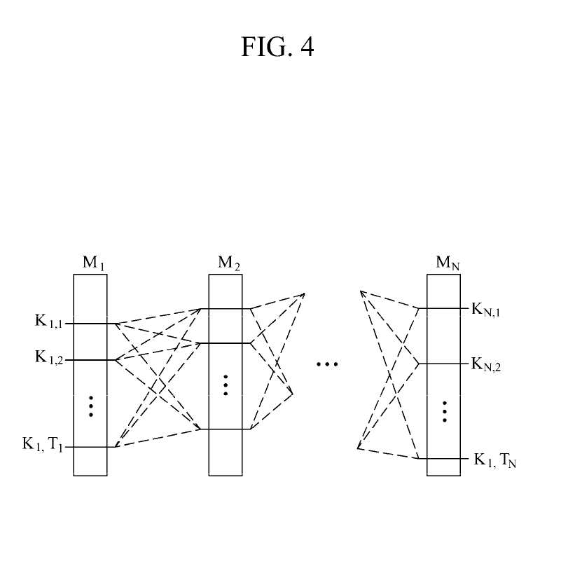

The editing apparatus in accordance with an embodiment of the present disclosure extracts key frames serving as keys from each of the sample motions. In this case, the key frames are extracted using zero-crossing information with respect to values of positions and moving velocities of key joints. However, the extracting method is not limited thereto. The editing apparatus groups postures corresponding to each other between the key frames into a posture group by comparing the extracted key frames of the respective sample motions with each other. Local coordinates of each joint having a root joint as a center are compared between the key frames of the respective sample motions, and postures corresponding to each other between the key frames are grouped into a posture group. The comparing of key frames extracted from sample motions and the grouping of postures in operation 200 of analyzing correlations between degrees of freedom of joints of sample motions will be described with reference to FIG. 4 later.

The editing apparatus in accordance with an embodiment of the present disclosure calculates correlations of intermediate joints included in each of the posture groups with respect to the key joint. In this case, correlations of the intermediate joints with respect to the key joint may be represented as correlation coefficient values by use of the rank-order correlation.

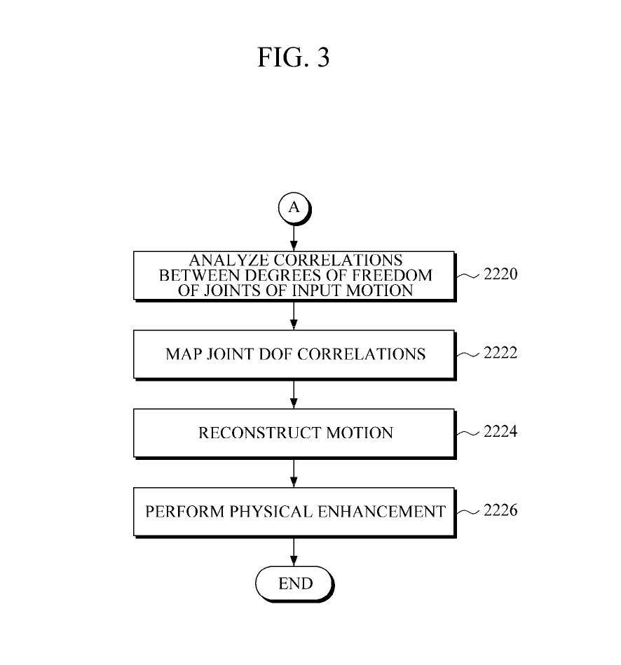

Thereafter, the editing apparatus receives an input motion in the form of a 3D character from a user (210). The editing apparatus generates a new character motion desired by the user by editing the input motion (220). In this case, as the user manipulates a key joint of the input motion, positions of other joints are transformed by use of correlations between degrees of freedom of joints, thereby generating a new character motion. The key joints may be designated as at least one of a neck joint, a wrist joint, an ankle joint and a root joint of the 3D is character. Alternatively, the key joint may be designated according to a setting of the user. Details of operation 220 of generating a new character motion in accordance with an embodiment of the present disclosure will be described with reference to FIG. 3 later.

FIG. 3 is a flowchart showing detailed process of operation 220 of generating a new character motion of FIG. 2 in accordance with an embodiment of the present disclosure.

Referring to FIG. 3, in operation 220 of generating a new character motion, the editing apparatus in accordance with an embodiment of the present disclosure analyzes correlation between degrees of freedom of joints of an input motion (2220). In this case, at least one key frame is extracted from the input motion, and correlations between degrees of freedom of joints are analyzed with respect to the extracted key frame.

The input motion is composed of a plurality of frames, for example, 30 fps (frames per second). Accordingly, it is not easy for a user to generate an animation by individually transforming all the frames. The editing apparatus in accordance with an embodiment of the present disclosure extracts key frames that serve as keys from the input motion. In this case, by only editing a posture included in the extracted key frames, in-between frames between the key frames are interpolated so that edited postures are reconstructed into a motion.

Thereafter, the editing apparatus maps the correlations between the degrees of freedom of the joints of the input motion analyzed in operation 2220 of analyzing correlations between degrees of freedom of joints of the input motion to the correlations between degrees of freedom of joint of the sample motion analyzed in operation 200 of FIG. 2 of analyzing correlation of degree of freedom of joint of sample motions (2222).

The editing apparatus in accordance with an embodiment of the present disclosure finds correlations of intermediate joints dependent on the key joint through operation 200 of FIG. 2 of analyzing correlations between degrees of freedom of joint of the sample motion, and in the mapping operation of 2222, compares a key frame obtained in operation 2220 of analyzing correlations between the degrees of freedom of the joints of the received motion with a key frame obtained in operation 200 of FIG. 2 of analyzing correlations between the degrees of freedom of the joints of the sample motion, so that postures corresponding to each other into the same posture group. That is, by comparing a posture group grouped in operation 200 of FIG. 2 of analyzing the correlations between degrees of freedom of joints of the sample motion with the input motion, a posture of the input motion corresponding to the posture group is included in the same posture group.

As the user manipulates a key joint, the editing apparatus reconstructs a motion desired by the user while transforming positions of other joints by use of the correlations between degrees of freedom of joints that are mapped in operation 2222 of mapping (2224).

In operation 2224 of reconstructing a motion, the editing apparatus in accordance with an embodiment of the present disclosure allows a user to manipulate the position of the key joint with respect to the key frame of the input motion. The manipulation of the position of the key joint may be repeatedly performed until a posture having a desired style is obtained. As the user manipulates a key joint, the editing apparatus adjusts the positions of intermediate joints by use of the correlations with respect to the key joint. During the adjusting of the positions of other joints, the positions of intermediate joints are adjusted according to an arrangement of joints included in a posture group. In this case, the positions of the intermediate joints are adjusted within a posture range included in a posture group with respect to the input motion.

In operation 2224 of reconstructing a motion (2224), at the same time of when the user changes the position of a key joint, the editing apparatus in accordance with an embodiment of is the present disclosure manipulates intermediate joints dependent on the key joint by use of the correlation coefficient values measured in operation 2000 of FIG. 2 of analyzing the correlations between degrees of freedom of joints of the sample motion in the inverse kinematics method. The positions of the intermediate joints are set to be changed as follows, according to the arrangement of joints included in the posture group.

$$\frac{{\sum }_{1}^{{N}_{k}} {P}_{i , j}}{{N}_{k}} \qquad [ Equation 1 ]$$

In Equation 1, Pi,j is the position of a j^{th} joint of an i^{th} key frame (Cj>0), Nk is the number of key frames belonging to the posture group. Cj is a correlation coefficient value measured with respect to the j^{th} joint.

If a user desires to additionally edit changed positions of the intermediate joints, an adjustable range of rotation of each intermediate joint is extracted from the posture group. Accordingly, the posture belonging to the key frame of the input motion is transformed only to similar postures included in the designated posture group.

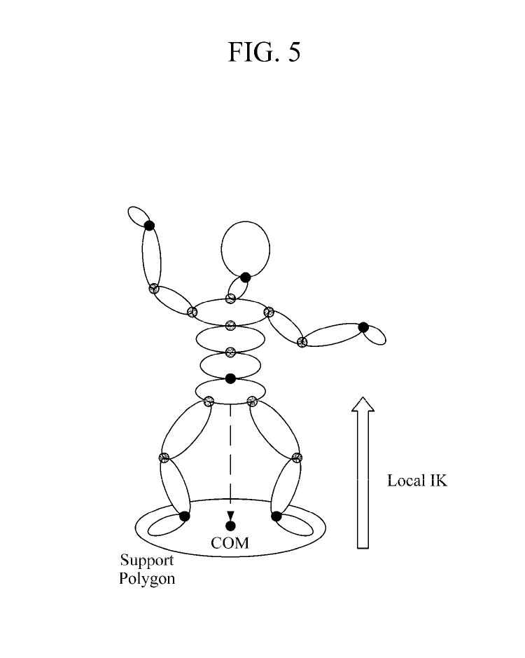

Thereafter, the editing apparatus physically enhances the motion reconstructed in operation 2224 of reconstructing a motion (2226). The editing apparatus in accordance with an embodiment of the present disclosure calculates the center of gravity of the reconstructed posture, checks a physical validity based on the calculated center of gravity, and relocates joints. In this case, joints of a lower part of a body are sequentially moved such that the center of gravity is included in a support polygon range. A moving range of the joints of the lower part of the body are limited to positions of the joints included in the posture group. Operation 2226 of the is physical enhancement will be described with reference to FIG. 5 later.

FIG. 4 is a reference diagram illustrating an example in which key frames extracted from sample motions are compared and postures are grouped in operation 200 of analyzing correlations between degrees of freedom of joints of the sample motion of FIG. 2.

As for a method of allowing a user to adjust rotations of a plurality of intermediate joints by use of position information of a key joint, the inverse kinematics method may be used. However, according to the inverse kinematics, positions of intermediate joint dependent on the key joint may vary with the final position of the key joint each time, and in order for a user to transform a desired posture, constraints need to be set at rotation values of the intermediate joints.

A process of setting constraints at the rotation values of all the intermediate joints takes a great amount of time. Accordingly, the editing apparatus in accordance with an embodiment of the present disclosure performs a posture transformation by use of the correlation obtained through the degree of freedom (DoF) correlation analysis between degrees of freedom of joints. Referring to FIG. 4, when a total of N sample motions is assumed, a total of TN key frames is found from an i^{th} sample motion (Mi))(1≦i≦N). In order to find a key frame including a posture important to the motion editing, zero-crossing information with respect to the position and the acceleration of the key joint is used.

A j^{th} key frame (Kj) of the sample motion Mi found as the above is compared with key frames of other sample motions, and is grouped together with key frames having postures corresponding to a posture of the j^{th} key frame into the same group. In this case, the comparing of postures between key frames may be achieved based on local coordinates of each joint having a root joint as a center. If a user puts emphasis on a posture of a certain part of a character, more weight may be assigned to joints included in the corresponding posture when the grouping of postures is performed. With respect to joints included in each group, correlations with respect to the key joint may be measured as correlation coefficient values through the Rank Correlation method. A correlation coefficient value measured with respect to a j^{th} joint may be defined as Cj.

FIG. 5 is a reference diagram illustrating a physical enhancement 2226 of FIG. 3 in accordance with an embodiment of the present disclosure.

Referring to FIG. 5, the editing apparatus in accordance with an embodiment of the present disclosure calculates the center of gravity from the posture reconstructed in operation 2224 of FIG. 3 of reconstructing a motion, and checks whether the center of gravity projected onto the support polygon is included in a range of the support polygon. If the center of gravity is deviated from the support polygon range, joints of a lower part of a body are sequentially moved until the center of gravity is included in the support polygon range by sequentially applying the Local Inverse Kinematics (Local IK) to all the joints of the lower part starting from one ankle placed on the ground to the other ankle The moving range of joints is determined in a convex hull space that is defined from the positions of the joints included in the key frames of the posture group generated in operation 200 of FIG. 2 of analyzing correlations between degrees of freedom of joints of the sample motion. That is, when Pi, j corresponding to a vertex of a convex hull is given, the position of a j^{th} joint of an input posture needs to satisfy with the following condition.

{Σⱼ₌₁^{N}^{ₖ}αⱼP_{i,j}|(∀j:αⱼ≦0) [symbol] Σⱼ₌₁^{N}^{ₖ}αⱼ=1} [Equation 2]

In Equation 2, αj is a weight value assigned to a j^{th} joint. Whenever the position of each joint is adjusted, the weight of gravity is newly calculated and compared with the weight of gravity of the original posture. Positions of joints of the lower part of the body are relocated while satisfying a condition that a difference between the centers of gravity of two postures do not exceed a threshold value designated by a user.

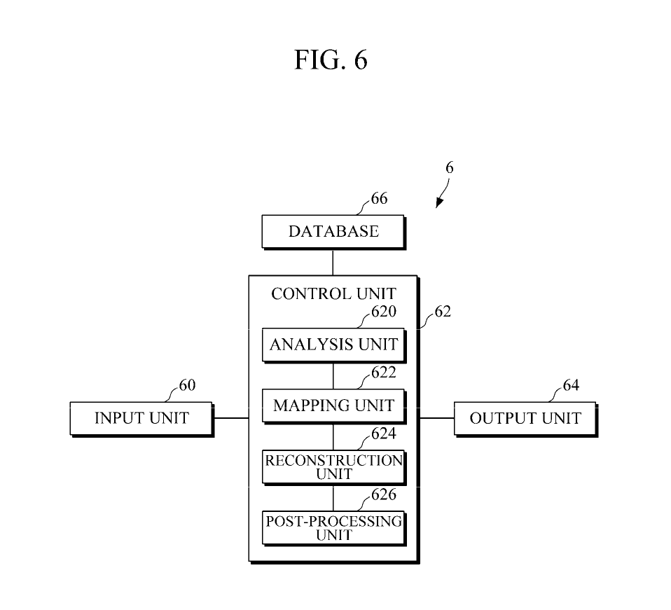

FIG. 6 is a block diagram illustrating a configuration of an editing apparatus 6 in accordance with an embodiment of the present disclosure.

Referring to FIG. 6, the editing apparatus 6 includes an input unit 60, a control unit 62, an output unit 64 and a database 66. The editing apparatus 6 may be implemented using motion editing software.

The input unit 60 receives an input motion provided in the form of a 3D character motion from a user. In order to edit the input motion into a character desired by the user, the input unit 60 receives a command to manipulate a key joint from a user. The database 66 stores a plurality of sample motions.

The control unit 62 analyzes correlations between degrees of freedom of joints from the plurality of sample motions stored in the database 66. When the user manipulates a key joint with respect to the input motion by use of the input unit 60, positions of other joints are transformed by use of the analyzed correlations between degrees of freedom of joints of the sample motions, thereby generating a new character motion. In this case, the key joint may be at least one of a neck joint, a wrist joint, an ankle joint and a root joint of the character, or a joint designated by the user. Other joints may be intermediate joints dependent on the key joint.

The control unit 62 according to an embodiment of the present disclosure may include an analysis unit 620, a mapping unit 622 and a reconstruction unit 624, and further include a post-processing unit 626.

The analysis unit 620 analyzes correlations between degrees of freedom of joints from a plurality of sample motion. When the plurality of sample motions are stored in the database 66, the analysis unit 620 analyzes correlations between degrees of freedom of joints by reading out the plurality of sample motions from the database 66.

The analysis unit 620 in accordance with an embodiment of the present disclosure extracts at least one key frame from each of the sample motions. In this case, the key frame is extracted by use of zero-crossing information with respect to the position and the velocity of the key joint, but the extraction method is not limited thereto. Thereafter, the extracted key frames of the respective sample motions are compared with each other, and postures corresponding to each other between the key frames are grouped into a posture group. In this case, local coordinates of each joint having a root joint as a center are compared between the key frames of the respective sample motions, and postures corresponding to each other between the key frames are grouped into a posture group. In addition, correlations of intermediate joints, included in each of the posture groups, with respect to a key joint are calculated. In this case, correlations of the intermediate joints with respect to the key joint may be represented as correlation coefficient values by use of the rank-order correlation

The mapping unit 622 analyzes correlations between degrees of freedom of joints of a motion received from a user, and maps the correlations between the degrees of freedom of the joints of the input motion to the correlations between degrees of freedom of joint of the sample motion.

After the analysis unit 620 obtains correlations of intermediate joints dependent on the key joint through analysis of correlations between degrees of freedom of joints of the sample motions, the mapping unit 622 in accordance with an embodiment of the present disclosure, in order to edit the input motion, extracts key frames from the input motion, and by use of the correlations between the degrees of freedom of joints of the sample motions analyzed through the analysis unit 620, compares the extracted key frame with the posture groups grouped by the analysis unit 620 such that postures corresponding to each other are included in the same group. Accordingly, as a user selects key frames of the input motion and changes the position of a key joint belonging to each key frame, the style of the input motion is edited. The user may repeatedly change the position of the key joint until a posture of a style desired by the user is obtained.

The reconstruction unit 624, when the user manipulates the key joint, reconstructs a motion desired by the user while transforming positions of other joints by use of the correlations between the degrees of freedom of the joints mapped by the mapping unit 622. The reconstruction unit 624 in accordance with an embodiment of the present disclosure adjusts positions of other joints by use of correlations of the joints with respect to the key joint, according to the manipulation of the key joint by the user. During the adjusting of the positions of the said other joints, the positions of the said other joints may be adjusted according to an arrangement of joints included in key frames of the posture group. With respect to the received motion, the positions of the said other joints are adjusted to be limited within a posture range to which the key frames included in the posture group belong. In this case, the reconstruction unit 624 may output a new character having a posture reconstructed through the reconstruction unit 624 on a screen through the output unit 64.

The post-processing unit 626 in accordance with an embodiment of the present disclosure calculates the center of gravity of the posture reconstructed through the reconstruction unit 624, checks a physical validity based on the calculated center of gravity, and relocates joints. At this time, joints of a lower part of a body are sequentially moved until the center of gravity is included in a range of a support polygon. A moving range of the joints of the lower part of the body may be limited to positions of the joints included in the posture group. Accordingly, a new character whose physical validity is checked is output on the screen through the output unit 64.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of editing a motion of a 3D character, the method comprising:
analyzing correlations between degrees of freedom of joints from a plurality of sample motions; and
generating a new character motion desired by a user by editing a 3D character motion input from the user, wherein when a key joint is manipulated by the user, positions of other joints are transformed by use of the analyzed correlations between degrees of freedoms of the joints, so that the new character motion is generated.

2. The method of claim 1, wherein the key joints include at least one of a neck joint, a wrist joint, an ankle joint and a root joint of the 3D character.

3. The method of claim 1, wherein the key joint is manipulated according to setting of the user.

4. The method of claim 1, wherein the analyzing of the correlations between degrees of freedom of the joints comprises:
extracting at least one key frame from each of the plurality of sample motions;
grouping postures corresponding to each other between the extracted key frames into a posture group by comparing the extracted key frames of the respective sample motions with each other; and
measuring correlations of intermediate joints included in each of the posture groups with respect to the key joint.

5. The method of claim 4, wherein in the extracting of the key frame, the key frame is extracted by use of zero crossing information with respect to values of a position and a moving velocity of the key joint.

6. The method of claim 4, wherein in the grouping of the postures, local coordinates of each joint having a root joint as a center are compared between the key frames in the respective sample motions, and postures corresponding to each other between the key frames are grouped into a posture group.

7. The method of claim 4, wherein in the grouping of the postures, during the comparing of the extracted key frames of the respective sample motions with each other, the extracted key frames are compared between each other after a weight is assigned to a joint included in a posture designated by the user such that the postures corresponding to each other between the extracted key frames are grouped into a posture group.

8. The method of claim 4, wherein in the measuring of the correlations of the intermediate joints with respect to the key joint, correlations of the intermediate joints with respect to the key joint are represented as correlation coefficient values by use of rank-order correlation.

9. The method of claim 1, wherein the generating of the new character motion comprises:
receiving a character motion from a user and analyzing correlations between degrees of freedom of joints of the received character motion;
mapping the correlations between the degrees of freedom of the joints of the received character motion to the correlations between degrees of freedom of joints of the sample motion; and
reconstructing a motion desired by the user while transforming positions of the said other joints by use of the mapped correlations between the degrees of freedom of the joints when the user manipulates the key joint.

10. The method of claim 9, wherein in the analyzing of the correlations between degrees of freedom of the joints of the received motion, with respect to at least one key frame extracted from the received motion, or a key frame extracted or designated according to setting of the user, correlations between degrees of freedom of joints are analyzed.

11. The method of claim 9, wherein the mapping comprises:
comparing a key frame obtained in the analyzing of the correlations between the degrees of freedom of the joints of the received motion with a key frame obtained in the analyzing of the correlations between the degrees of freedom of the joints of the sample motion; and
mapping postures corresponding to each other between the key frame of the received motion and the key frame of the sample motion into the same posture group.

12. The method of claim 9, wherein the reconstructing of the motion comprises:
manipulating, by the user, a key joint with respect to the received motion; and
adjusting positions of the said other joints by use of correlations with respect to the key joint according to the manipulation of the key joint by the user.

13. The method of claim 12, wherein in the adjusting of the positions of the said other joints:
positions of the said other joints are adjusted according to an arrangement of joints included in key frames of a posture group,
wherein the posture group represents a group of key frames having postures that are determined to correspond to each other based on the correlations between degrees of freedom of joints.

14. The method of claim 13, wherein in the adjusting of the positions of the said other joints,
with respect to the received motion, positions of the said other joints are adjusted to be is limited within a posture range to which the key frames included in the posture group belong.

15. The method of claim 9, wherein the generating of the new character motion further comprises:
performing physical enhancement by calculating a center of gravity of the reconstructed posture, checking a physical validity based on the calculated center of gravity and relocating joints.

16. The method of claim 15, wherein in the performing of the physical enhancement,
joints of a lower part of a body are sequentially moved until the center of gravity is included in a range of a support polygon.

17. The method of claim 16, wherein in the performing of the physical enhancement,
a moving range of the joints of the lower part of the body is limited to positions of the joints included in the posture group, and
wherein the posture group represents key frames having postures that are determined to correspond to each other based on the correlations between degrees of freedom of joints.

18. An apparatus for editing a 3D character motion, the apparatus comprising:
an input unit configured to receive a 3D character motion from a user;
a database configured to store a plurality of sample motions; and
a control unit configured to analyze correlations of degrees of freedom of joints with respect to the plurality of sample motions stored in the database, and when a key joint is manipulated by the user with respect to the input motion, generate a new character motion by transforming positions of other joints by use of the analyzed correlations of degrees of freedom of joints.

19. The apparatus of claim 18, wherein the control unit comprises:
an analysis unit configured to analyze correlations between degrees of freedom of joints from a plurality of sample motions;
a mapping unit configured to analyze correlations between degrees of freedom of joints of a motion received from the user, and map the correlations between degrees of freedom of joints of the received motion to the correlations between degrees of freedom of joints of the sample motion; and
a reconstruction unit configured to reconstruct a motion desired by the user while transforming positions of the said other joints by use of the correlations of degrees of freedom of joints mapped by the mapping unit when a key joint is manipulated by the user through the input unit.

20. The apparatus of claim 19, wherein the control unit further comprises a post-processing unit configured to calculate a center of gravity of the reconstructed posture reconstructed through the reconstruction unit, check a physical validity based on the calculated center of gravity and relocate joints.
